(19) United States
(12) Patent Application Publication
(10) Pub. No.: US 2015/0352705 A1
(43) Pub. Date: Dec. 10, 2015

(54) System and Method for Installing Fixtures in Tight Spaces

(71) Applicant: KV Innovations, LLC, Comfort, TX (US)

(72) Inventors: Kenneth Lee Matthews, Jr., Comfort, TX (US); Vaughn Jim Colbath, Mountain, TX (US)

(21) Appl. No.: 14/297,627

(22) Filed: Jun. 6, 2014

(51) Int. Cl. B25F 1/02; B25B 13/06; B25B 15/00; B25B 13/46

(52) U.S. Cl. CPC B25F 1/02; B25B 13/461; B25B 13/06; B25B 15/007

(57) ABSTRACT

A tool for installing fixtures in tight spaces is herein disclosed. The tool comprises a bolt breaker and a driver. The bolt breaker comprises a head and a shaft. The shaft comprises a first end portion and a second end portion. The first end portion attached with the head. The second end portion has a mateable section. The driver has a tubular body, connectable with the mateable section. The driver comprises a pair of sockets and a grip. Each of the sockets placed at opposite ends of the driver. The grip comprises a plurality of protruding portions. The protruding portions are connected to the outer middle section of the tubular body.

### BACKGROUND

This disclosure relates to a system and method for installing fixtures in tight spaces.

Installing fixtures such as toilet or water heater stand are some of the most common tasks performed in tight spaces. Most of the time, common hand driven tools such as pliers, or nuts driver are used to perform installation of toilet fixtures. However, using a pair of pliers to tighten nuts and bolts in limited space can be very inconvenient and hard to accomplish. This holds true when installing a toilet tank that are usually placed against a wall. Nuts driver can also be used to accomplish this task. However, nut drivers do not have deep sockets, which tend to bottom out on a toilet tank. Furthermore, a plumber often carries more than one device to install a common fixture. Therefore it can be convenient to have a single device that can be used for most installation jobs.

As such it would be useful to have a system and method for installing fixtures in tight spaces.

### SUMMARY

A tool for installing fixtures in tight spaces is herein disclosed. The tool comprises a bolt breaker and a driver. The bolt breaker comprises a head and a shaft. The shaft comprises a first end portion and a second end portion. The first end portion attached with the head. The second end portion having a mateable section. The driver having a tubular body, connectable with the mateable section. The driver comprises a pair of sockets and a grip. Each of the sockets placed at opposite ends of the driver. The grip comprises a plurality of protruding portions. The protruding portions are connected to the outer middle section of the tubular body.

A method for installing a toilet fixture is herein disclosed. Specifically, the method comprises the steps of disconnecting a bolt breaker from a driver, and fastening a first nut to a first bolt on a fixture with a first socket on a first end of the driver. Additionally the method comprises fastening a second nut to a second bolt on the fixture with a second socket on a second end of the driver, breaking a portion of the first bolt using the bolt breaker, and reconnecting the bolt breaker to the driver.

### BRIEF DESCRIPTION OF THE DRAWINGS

FIG. 1 illustrates a driver device comprising a bolt breaker and a driver.

FIG. 2A illustrates bolt breaker comprising a shaft.

FIG. 2B illustrates a sectional view of a head mateable with a shaft.

FIG. 2C illustrates another embodiment of bolt breaker further comprising a flat head screwdriver.

FIG. 3A illustrates a sectional view of driver comprising a pair of sockets, and a grip.

FIG. 3B illustrates another embodiment of a driver wherein both sockets comprises a ratcheting mechanism.

FIG. 3C illustrates a front view of socket.

FIG. 4A illustrates a threaded-fastening method embodiment of mateable section.

FIG. 4B illustrates a quick-release embodiment of mateable section.

FIG. 5A illustrates how driver can be used in installing a toilet.

FIG. 5B illustrates how second socket can be used to fasten nuts at the bottom of a toilet tank.

FIG. 6A illustrates how bolt breaker can be used in cutting an excess portion of a bolt.

FIG. 6B illustrates driver being maneuvered to remove excess portion of bolt.

FIG. 6C illustrates excess portion removed from a bolt.

FIG. 6D illustrates head removed from shaft to take out excess portion of bolt.

### DETAILED DESCRIPTION

Described herein is a system and method combining a bolt breaker and a nut driver. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

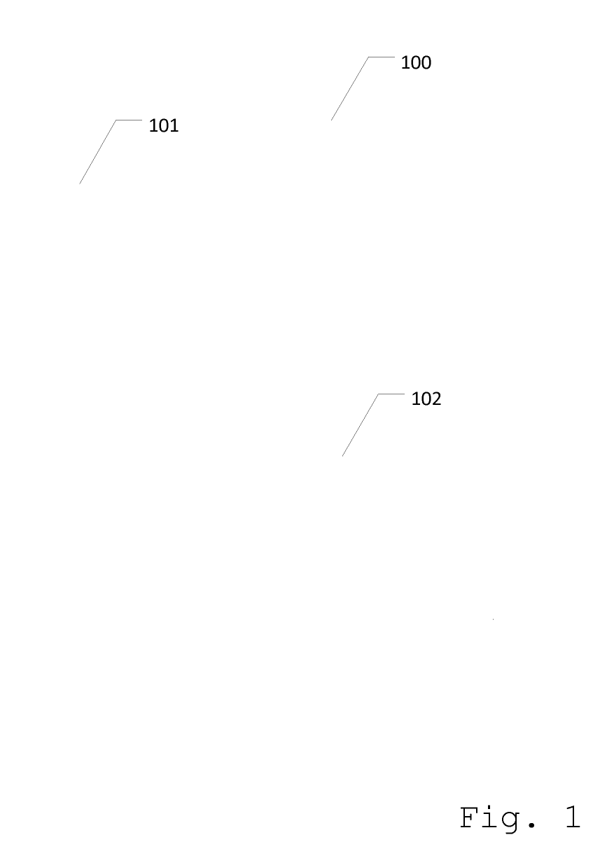

FIG. 1 illustrates a driver device 100 comprising a bolt breaker 101 and a driver 102. Driver device 100 can be a handheld device that is used to fasten nuts and bolts in areas with tight spaces such as water heater stand, toilet bowl and tank. Driver device 100 can be made of durable materials that include but are not limited to steel, chromium, nickel, and/or plastics. Further, a portion of driver 102 can be connectable with a portion of bolt breaker 101.

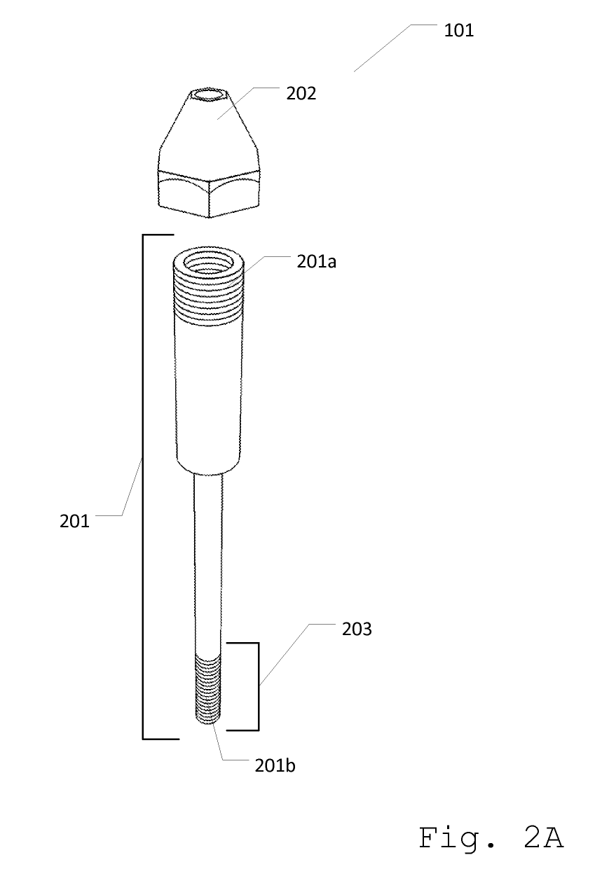

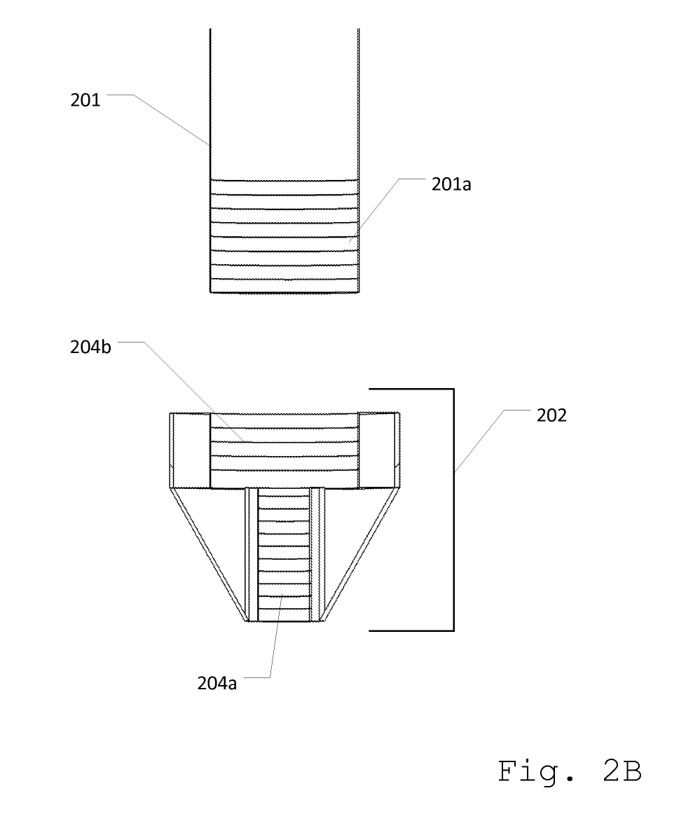

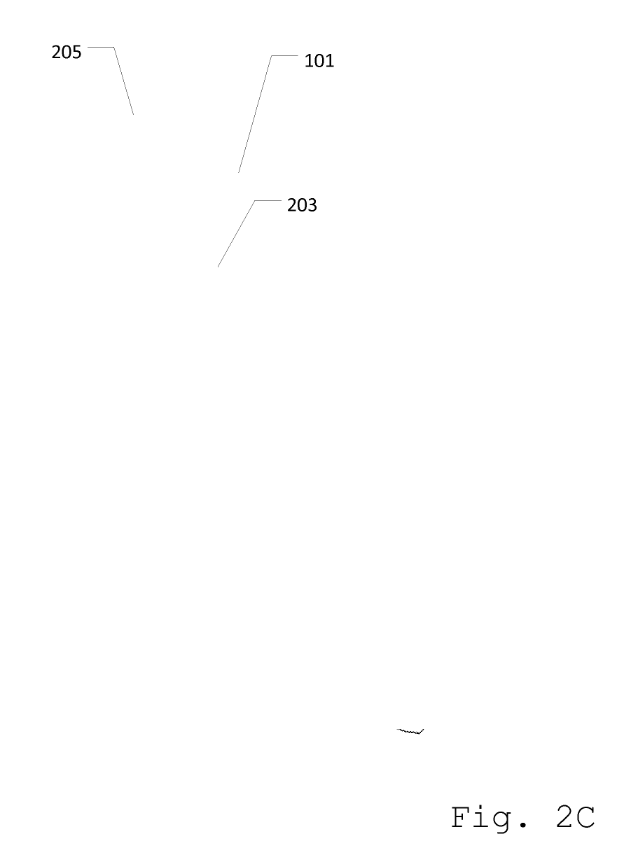

FIG. 2A illustrates bolt breaker 101 comprising a shaft 201. Shaft 201 can comprise a first end portion 201a and a second end portion 201b. First end portion 201a can comprise a head 202. In one embodiment, head 202 can have a quarter inch thread that can comprise a 12-point head that can fit 12 point bolts. Additionally, first end portion 201a can be hollow on the inside to allow the bolt to slide through the inside of first end portion 201a. In one embodiment, head 202 can be permanently attached on first end portion 201a through molding, cementing, or through the use of any adhesives. In another embodiment, head 202 can be removable from shaft 201. Thus, when the bolt gets stuck while trying to cut it, the user can remove head 202 and take out the part that got stuck. Furthermore, head 202 can have a conical shape that can allow bolt breaker 101 be bent back and forth easily. Second end portion 201b can comprise a mateable section 203. Mateable section 203 can be a portion of shaft 201 that is used to connect bolt breaker 101 with driver 102.

FIG. 2B illustrates a sectional view of head 202 mateable with shaft 201. In an embodiment wherein head 202 can be removable from first end portion 201a, head 202 can comprise a first inner thread 204a and a second inner thread 204b. First inner thread 204a can be the portion of head 202 that is connectable to a bolt. Second inner thread 204b can be the portion of head 202 can be the portion that is mateable with first end portion 201a.

FIG. 2C illustrates another embodiment of bolt breaker 101 further comprising a flat head screwdriver 205. In this embodiment, mateable section 203 can form a flat head screwdriver. As such, bolt breaker 101 can also be used to fasten slotted fasteners such as a screw.

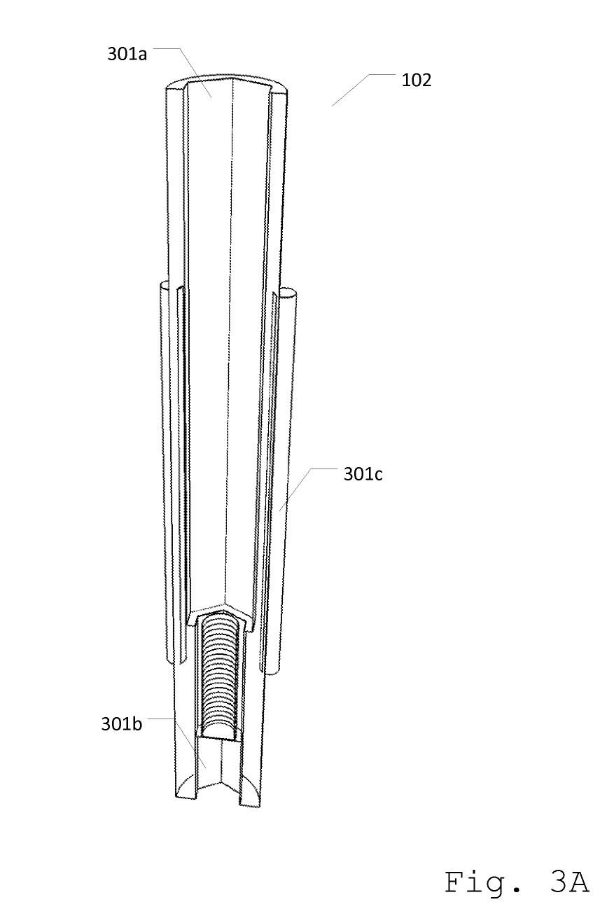

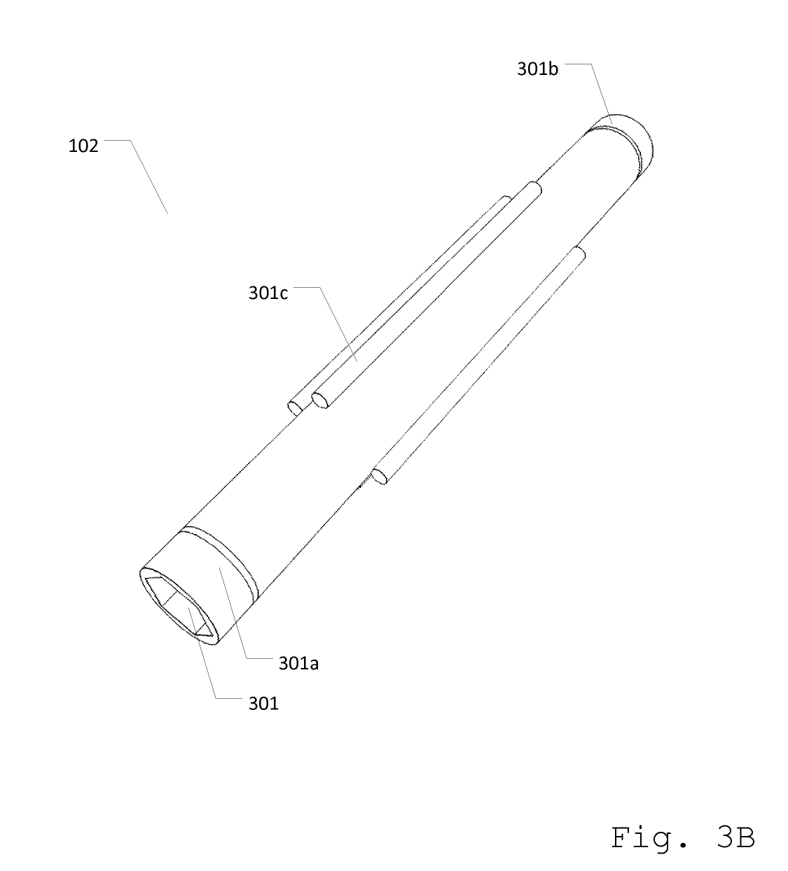

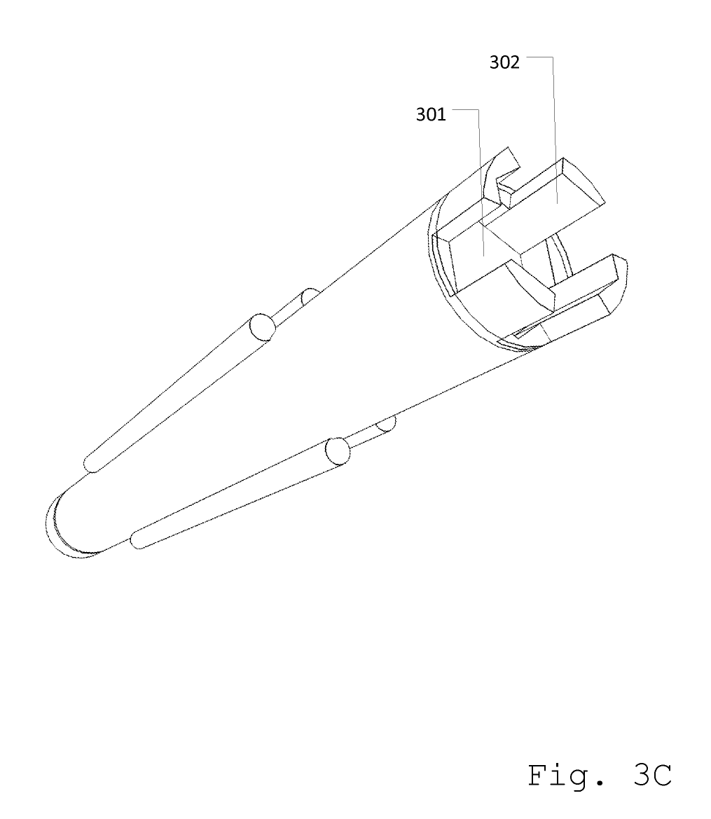

FIG. 3A illustrates a sectional view of driver 102 comprising a pair of sockets 301, and a grip 301c. Driver 102 can have a tubular body that is made of durable material such as steel, or any other metal or metal alloy known in the art of handheld tools. Sockets 301 can comprise of six-sides, which can accommodate a square head bolt, and a hex head bolt. In one embodiment, one end of socket 301a can comprise a 7/16″ driver while the other end socket 301b can comprise a ½″ driver. Moreover, sockets 301 can be deep sockets to allow bolt to slide through and not bottom out. In one embodiment, sockets 301 can be magnetic so that nuts and bolts do not easily slip off from the sockets. Grip 301c can comprise a plurality of protruding portions 302 that can allow user to hold driver 102 securely. In this embodiment, protruding portions 302 can be placed around the middle section of tubular body 301. As shown in FIG. 3, grip 301c can comprise a plurality of parallel vertical protrusions intermittently placed around the exterior of driver 102. Grip 301c can aid user in rotating driver 102 effectively. Furthermore, grip 301c can be used as a stand. In one embodiment protruding portions 302 can be made of the same material used for tubular body 301. In another embodiment, protruding portions 302 can be made of light and durable material such as rubber or plastic. As such, grip 301c can act as an insulator. Moreover, using such materials can prevent driver 102 from slipping off from a users hand. This can be helpful especially on a hot day when body or hands tends to be sweaty.

FIG. 3B illustrates another embodiment of driver 102 wherein both sockets 301 comprises a ratcheting mechanism. In such embodiment, sockets 301 can allow a rotary motion in only one direction while preventing motion in the opposite direction. For purposes of this disclosure, ratcheting mechanism can allow sockets 301 to rotate separately from grip 301c portion of driver 102. This feature can eliminate the need for repositioning driver 102 and can prevent the rounding off of bolts. As such, driver 102 can be actuated in one direction without loosening the bolt. Furthermore, actuating driver 102 in the other direction can allow socket 301 to turn in the same direction with driver 102.

FIG. 3C illustrates an embodiment of sockets 301. In this embodiment, sockets 301 can comprise a plurality of extended portions 302. Extended portions 302 can protrude form at the edges of sockets 301. In one embodiment, at least four extended portions 302 can be placed around the edges of sockets 301. As such, a square head bolt, and a hex head bolt can connect securely onto sockets 301.

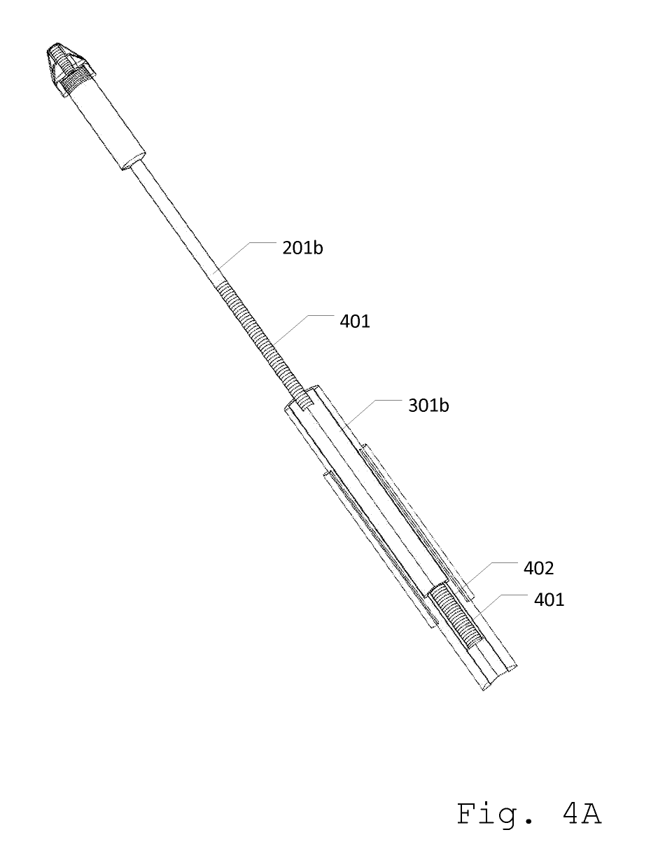

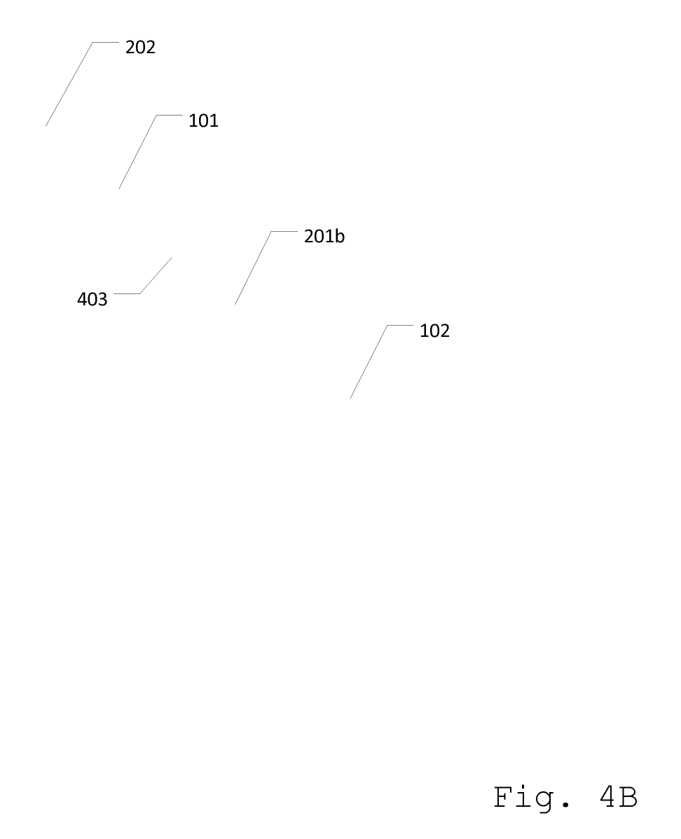

FIG. 4A illustrates a threaded-fastening method embodiment of mateable section 203. In this embodiment, second end portion 201b can comprise a threaded portion 401. As such, the inner portion of one of said sockets 301 can comprise a threaded slot 402 that can be mateable with threaded portion 401. Therefore, threaded portion 401 can be inserted within threaded slot 402 to connect shaft 201 with driver 102. In such embodiment, threaded portion 401 of bolt breaker 101 can be fastened with driver 102 by screwing threaded portion 401 onto threaded slot 402. Thus, connecting bolt breaker 101 and driver 102 together.

FIG. 4B illustrates a quick-release embodiment of mateable section 203. In such embodiment, second end portion 201b can use a quick-release pin that can include but is not limited to a ball pin or ball bearings. In this embodiment, second end portion 201b can comprise a ball bearing 403. Thus, when shaft 201 of bolt breaker 101 is pulled from driver 102, ball bearing 403 can be pushed within shaft 201 allowing bolt breaker 101 to come apart with driver 102. Furthermore, re-inserting shaft 201 within one of sockets 301 can allow mateable section 203 be fastened onto driver 102.

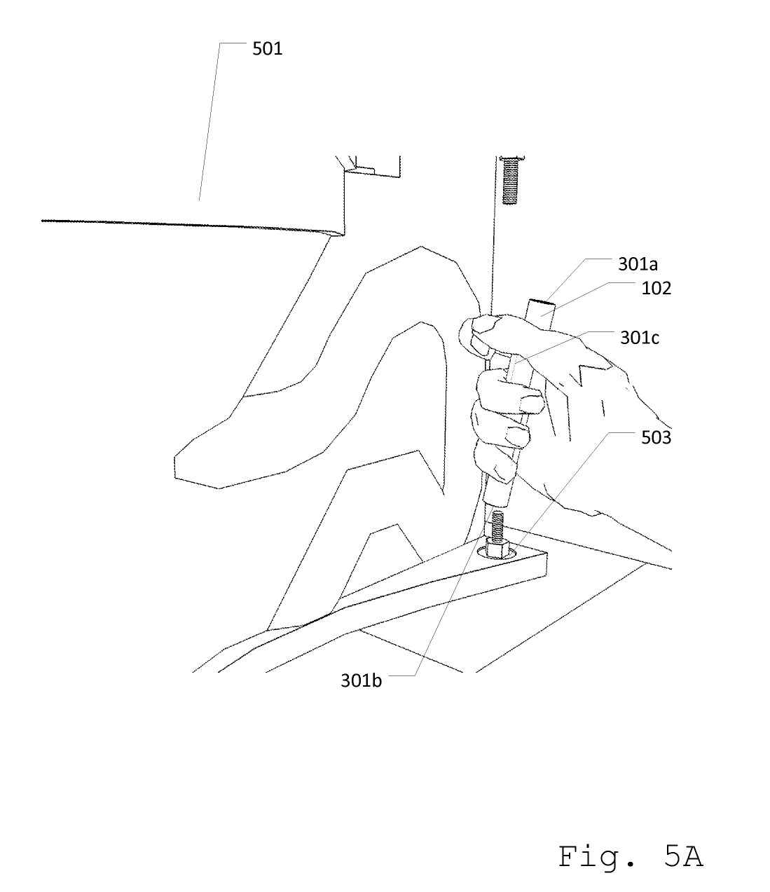

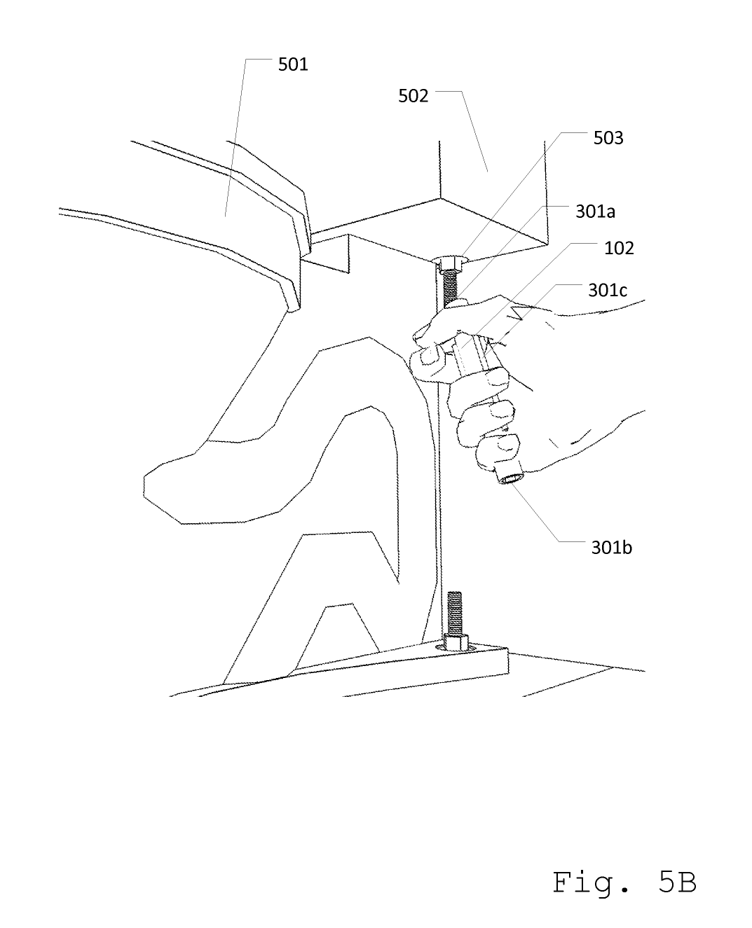

FIG. 5A illustrates how driver 102 can be used in installing a toilet 500. For purposes of this disclosure, toilet 500 can comprise of two major components a toilet bowl 501 and a toilet tank 502. Toilet 500 can further comprise a plurality of slots 503. Slots 503 can be holes placed on toilet 500 wherein bolts can be positioned and fastened. A first set of slots 503a can be at the base of toilet bowl 501. A second set of slots 503b can be placed at the bottom of toilet tank 502. First socket 301a of driver 102 can be used to fasten 7/16-inch nuts at the base of toilet bowl 501 by placing first socket 301a on 7/16-inch nuts. Once in place, driver 102 can be rotated using grip 301c to tighten 7/16 nuts on a bolt.

FIG. 5B illustrates how second socket 301b can be used to fasten nuts at the bottom of toilet tank 502. In this embodiment, second socket 301b can be used to fasten ½ inch nut at the bottom of toilet tank 502. As such, second socket 301b can be placed on ½ inch nut. Then, driver 102 can be rotated using grip 301c to tighten ½ inch nut on the bolt at the bottom of toilet tank 502. Grip 301c can help user to securely tighten the nuts in place. Moreover, the nuts and bolts placed at the back portion of toilet tank 502 are usually placed against the back of the wall. Thus, grip 301c can be essential in helping the user tighten the nuts that are placed on small spaces.

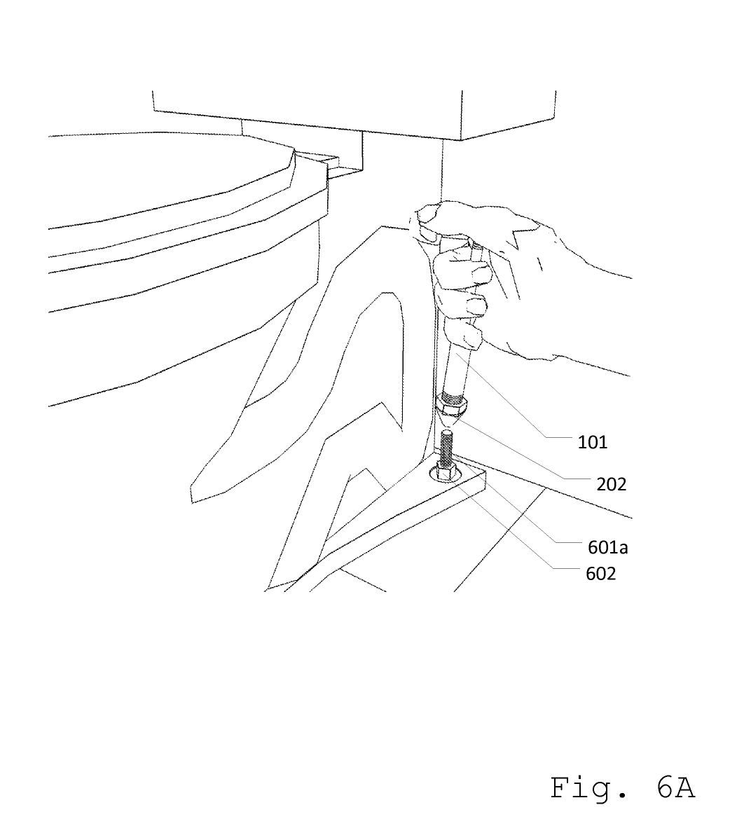

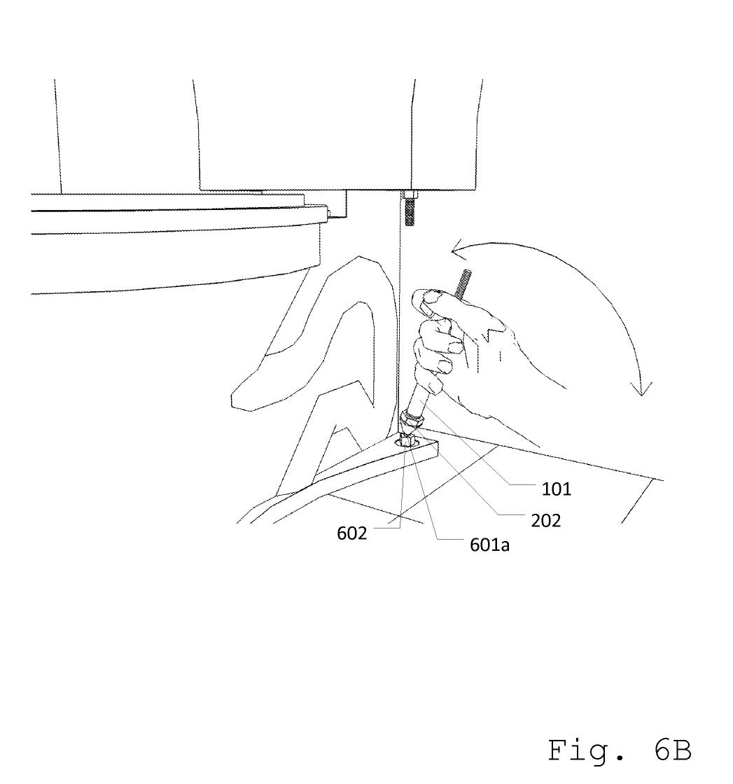

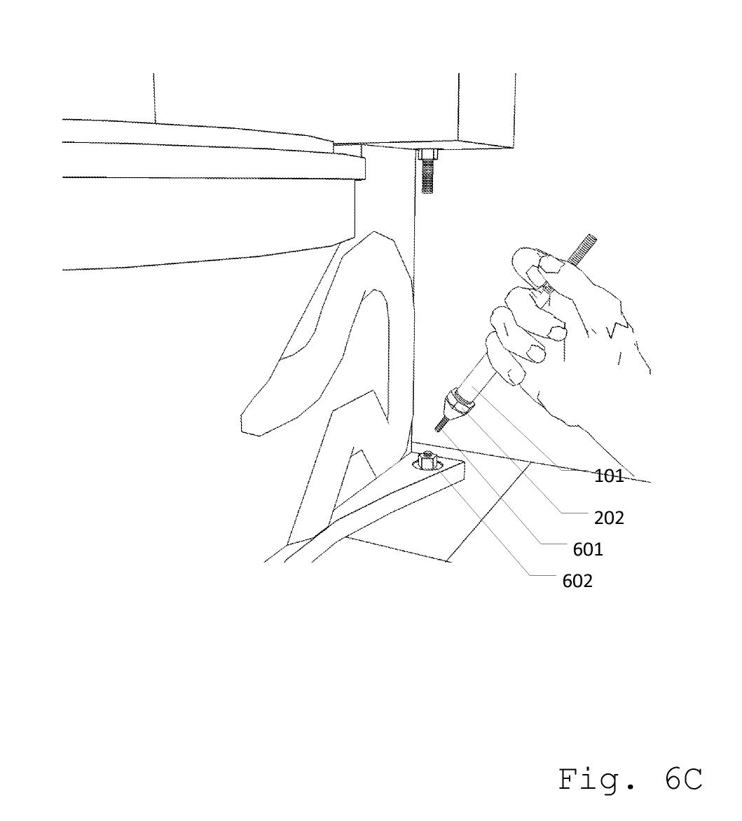

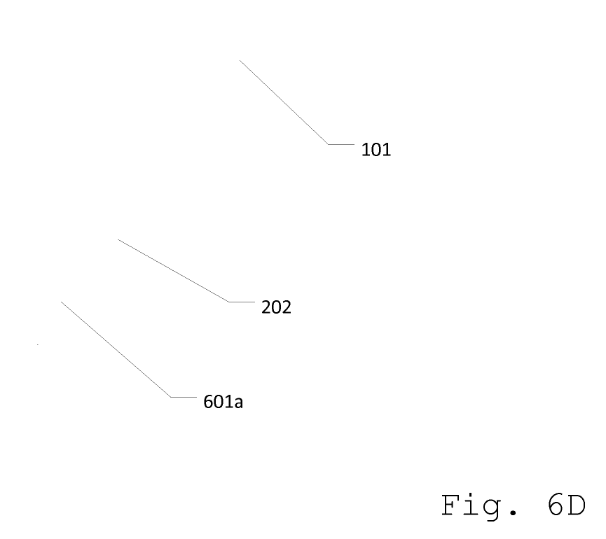

FIG. 6A illustrates how bolt breaker 101 can be used in cutting an excess portion 601a of a bolt 601. Once nuts and bolts are securely fastened on each slot 503, bolt breaker 101 can be used to remove excess portion 601a. Using bolt breaker 101, head 202 can be screwed into excess portion 601a.

FIG. 6B illustrates driver 102 being maneuvered to remove excess portion 601 a of bolt 601. When head 202 is securely fastened just above a nut 602, which is placed at the base of toilet bowl 501, bolt breaker 101 can be bended back and forth until excess portion 601a breaks.

FIG. 6C illustrates excess portion 601 a removed from bolt 601. As such, excess portion 601a can be easily removed by unscrewing excess portion 601a from head 202.

FIG. 6D illustrates head 202 removed from shaft 201 to take out excess portion 601a of bolt 601. In a scenario wherein excess portion 601a gets stuck within bolt breaker 101, head 202 can be removed from shaft 201. Removing head 202 from first end portion 201 a can help user access the portion of the bolt that got stuck within bolt breaker 101.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A tool for installing fixtures in tight spaces comprising
a bolt breaker, said bolt breaker comprising
a head; and
a shaft comprising a first end portion and a second end portion, said first end portion attached with said head, further wherein said second end portion having a mateable section; and
a driver having a tubular body, connectable with said mateable section comprising
a pair of sockets, each of said sockets placed at opposite ends of said driver; and
a grip comprising a plurality of protruding portions, wherein said protruding portions are connected to the outer middle section of said tubular body.

2. The system of claim 1 wherein said mateable section comprises a first threaded portion mateable with a second threaded portion on the inside of said driver.

3. The system of claim 2 wherein said mateable section further comprises a flat head screwdriver.

4. The system of claim 1 wherein said mateable section comprises a quick release.

5. The system of claim 1 wherein said head is removable from said first end portion.

6. The system of claim 5 wherein said head comprising
a first inner thread connectable to a bolt of a fixture; and
a second inner thread mateable with said first end portion.

7. The system of claim 6 wherein said head is in conical shape.

8. The system of claim 7 wherein said quarter-inch thread is hollow on the inside.

9. The system of claim 5 wherein said head comprises a quarter-inch thread.

10. The system of claim 1 wherein said sockets are magnetic.

11. The system of claim 1 wherein one of said socket comprises a 7/16 inch driver.

12. The system of claim 11 wherein the other said socket comprises a ½ inch driver.

13. The system of claim 1 wherein said sockets comprise a plurality of extended portion connectable to a bolt.

14. The system of claim 1 wherein at least one of said sockets comprises a ratcheting mechanism.

15. A method for installing a toilet fixture comprising the steps of
disconnecting a bolt breaker from a driver;
fastening a first nut to a first bolt on a fixture with a first socket on a first end of said driver,
fastening a second nut to a second bolt on said fixture with a second socket on a second end of said driver;
breaking a portion of said first bolt using said bolt breaker; and
reconnecting said bolt breaker to said driver.

16. The method of claim 15 wherein one of said socket comprises a 7/16 inch driver.

17. The method of claim 16 wherein the other said socket comprises a ½ inch driver.

18. The method of claim 15 wherein breaking an excess portion of said first bolt using said bolt breaker comprising
screwing a head of said bolt breaker onto said excess portion, further wherein the other end of said bolt breaker comprises a shaft;
moving said shaft back and forth to break off said excess portion.

19. The method of claim 18 comprising the step of unscrewing said excess portion from said head to remove said bolt from said bolt breaker device.

20. The method of claim 19 wherein said head comprises a quarter-inch thread.
